(19) United States
(12) Patent Application Publication
(10) Pub. No.: US 2007/0271281 A1
(43) Pub. Date: Nov. 22, 2007

(54) COMPUTERIZED SYSTEM FOR DATA COLLECTION AND MANAGEMENT

(75) Inventor: Ramiro Mendes Maranhao, Sao Paulo City (BR)

Correspondence Address: LUCAS & MERCANTI, LLP, 475 PARK AVENUE SOUTH, 15TH FLOOR, NEW YORK, NY, 10016, US

(73) Assignee: AUDIT BUSINESS SOLUTIONS LTDA., San Paulo City (BR)

(21) Appl. No.: 11/737,394

(22) Filed: Apr. 19, 2007

Related U.S. Application Data
(63) Continuation-in-part of application No. 11/248,917, filed on Oct. 12, 2005.
(60) Provisional application No. 60/618,029, filed on Oct. 12, 2004.

(51) Int. Cl. G06F 7/00

(52) U.S. Cl. 707/100; 707/E17.005

(57) ABSTRACT

Data collection and management system using portable computerized data collection equipment, such as, for instance, a handheld or palmtop device, and a mainframe computer which incorporates a database. Information about visitors to a commercial store may be collected and stored via the portable electronic equipment, and then transferred to the mainframe. The collected data is analyzed at the mainframe in order to generate electronic statistical reports and spreadsheets, whose results may be automatically made available to improve traffic of people in the commercial stores.

This application is a continuation-in-part of U.S. patent application Ser. No. 11/248,917 filed Oct. 12, 2005, which claims priority under 35 U.S.C. 119(e) of U.S. provisional patent application Ser. No. 60/618,029 filed Oct. 24, 2004, both of which are incorporated reference.

### FIELD OF INVENTION

The present invention relates generally to a computerized portable system for research information collection and management, for example, for use in audits, and more specifically, to a computerized portable system for research information collection and management for use in audits at commercial establishments, such as individual stores and groups of stores, such as chain stores, commercial centers, and shopping malls, with the possibility of being adapted for use in franchise systems, airports, bus stations, and others.

The present invention also relates generally to an auditing system and method for enabling audits of commercial establishments.

### BACKGROUND OF THE INVENTION

There exist various techniques to control the movement of people in places with large demographic concentrations, and, more specifically, in commercial centers, where the peoples' primary activities are related to their personal interests. Shoppers expect assistance from employees in commercial establishments regardless of the market segments being handled in the commercial establishment. The employees must be able to provide full assistance to shoppers, not only regarding the prompt supply of goods and/or services being offered at the establishment, but especially to guarantee the safety and wellbeing of the shoppers while they are in the establishment or commercial center in which the establishment is situated.

Generally, commerce is segmented into several different industries or areas of activities which are often grouped according to the requirements and the needs of the consumers. Accordingly, the business potential for a certain commercial outlet will be a parameter necessary to establish several criteria, not only for this specific business's operation, but also for the commercial environment as a whole. These criteria may include a determination of an appropriate rental values for the space being occupied by the commercial establishment to a determination of the operating hours of the establishment. Regarding supply of goods for the establishment, the criteria may include establishing a price policy to be used in the establishment, and use and application of promotions.

At present, most if not all methods used to control movement of people in commercial centers seek primarily if not exclusively to measure each store's monthly sales, in an attempt to determine an appropriate rental value for the space occupied by each store. Rental value is thus often dependent on sales turnover and the type of commercial or business activity being conducted by each store. However, a major inconvenience of such techniques is that data collection is performed by hand, i.e., handwritten, for later evaluation. This is an extremely slow process, both when collecting data and transcribing such data. Moreover, the process is subject to inaccuracies, due to the risk of loss or changing of information when transferring it to a mainframe computer which performs the analysis of the gathered data.

### OBJECTS AND SUMMARY OF THE INVENTION

It is an object of the present invention to provide a new computerized system for data collection and management.

It is another object of one or more embodiments of the present invention to provide a new computerized system for data collection and management which uses portable computerized data collection equipment.

It is another object of one or more embodiments of the present invention to provide a new computerized system for data collection and management which overcome disadvantages of prior art systems.

In order to achieve one or more of these objects and possibly others, one embodiment of a system for data collection and management in accordance with the invention involves the collection and registering of data related to the movement or traffic of people in commercial stores or establishments using an application in a handheld or palmtop device or similar device. The palmtop platform is capable of being connected via a cable, a fixed support connection, networks or wireless transfer, to a database such that the information gathered by the handheld platform is transferred to the database. The database is preferably installed and configured on a mainframe. On the mainframe, the information collected is processed and correlated and pre-defined temporal and statistical parameters are determined to allow for the electronic tabulation of such data. The electronic tabulation provides a high level of reliability, security, and agility, thus providing for a low cost procedure and technique for generating an improvement in the control and monitoring of the traffic of people in commercial stores.

In accordance with the invention, it is possible to allow an entity in charge of operational control of a single store or even a commercial center, to adopt, in real time, measures needed to assure the comfort, well-being and safety of visitors, including optimization of the facilities available for the store or the entire commercial center. The invention also utilizes reports and electronic spreadsheets for the results which can be automatically made available for verification.

In one embodiment of the invention, the system allows for instantaneous monitoring of traffic of people in a single commercial store or in a group or set of commercial stores with a view toward optimizing operation thereof in order to meet the visitors' interests. These interests include the supply of the goods being sought, the comfort and well-being of the shoppers while shopping in the commercial store or a commercial center containing such stores.

In one embodiment, the system includes two interactive modules, a first data collection module which performs the data entry and registration representing the traffic of people in a commercial store or commercial center, and a second data processing module. The data about the shoppers being entered into or received by the first module may include personal data, both the actual buyers' data and their companions' data, such as, for example, sex and age, in addition to data related to the operation of the commercial store per se, such as occupation of the store, item exposure condition; absence of items; service time; actualization of a sale or absence thereof; waiting time to pay for the items, and others. Collection of such data is preferably performed with the assistance of an application installed in a portable electronic device which transfers immediately, via a cable, a fixed connection support, networks and/or wireless transfer, to the second module. The second module includes a personal computer (PC) of the like including a database where the collected data is tabulated and otherwise analyzed, thus enabling generation of electronic reports and spreadsheets These reports and spreadsheets may be made available for verification automatically. This allows optimization of the operation, not only of a single commercial store or sales establishment, but also of a commercial center containing a multitude of such stores or establishments as a whole.

Another way to consider the invention is as a system which includes a handheld or palmtop device or similar device, in addition to a mainframe which incorporates a database where the information captured by the handheld device is stored. This transfer may be effected via a cable, a fixed connection support, a network and/or via wireless transfer. The database is to be operated through a computer program which will receive the uploaded data and run correlations with the system's pre-established parameters, in a systematic and precise way, thus generating statistical reports and electronic spreadsheets. The reports and spreadsheets or results therefrom may be made available automatically thereby allowing better control and management of the traffic of people in commercial stores and establishments.

### BRIEF DESCRIPTION OF THE DESIGNS

For a better understanding regarding the computerized system for data collection and management in accordance with the invention, reference is made to the accompanying drawings in which:

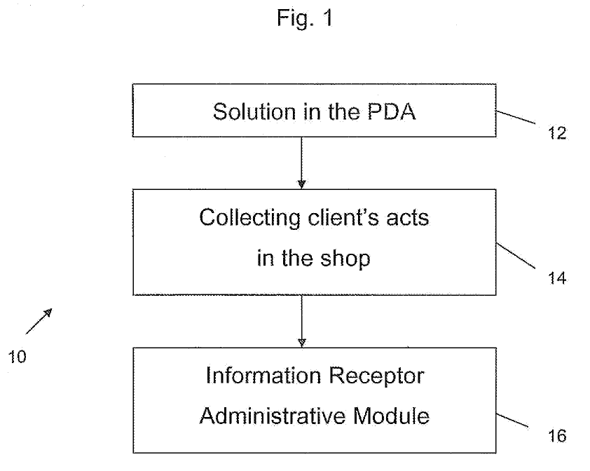

FIG. 1 illustrates a block diagram of the general operation of a computerized system for data collection and management in accordance with the invention;

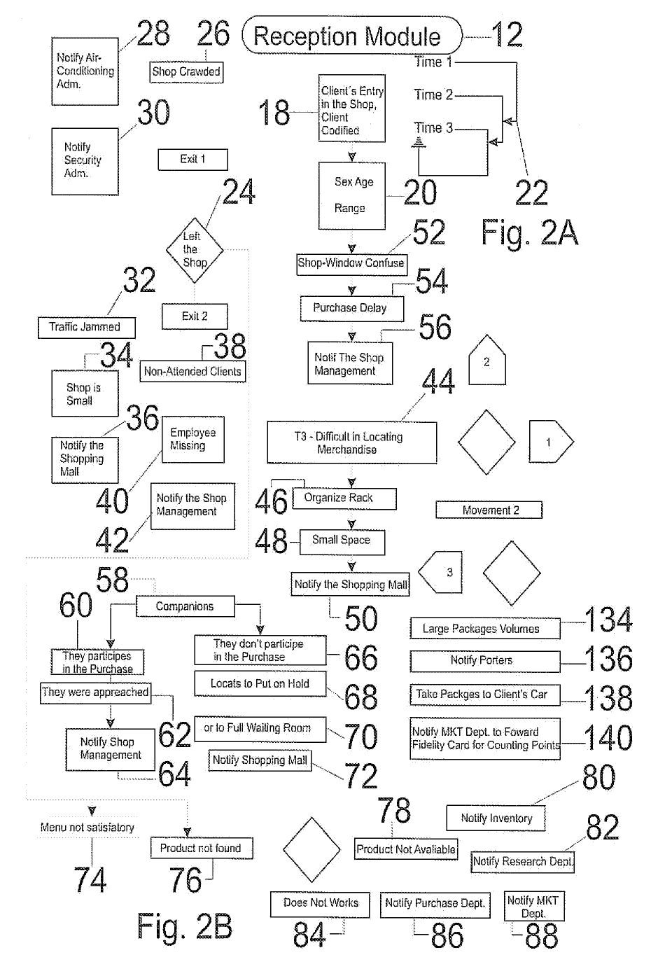

FIGS. 2A and 2B illustrate block diagrams of the general operation of a data gathering module in accordance with the invention;

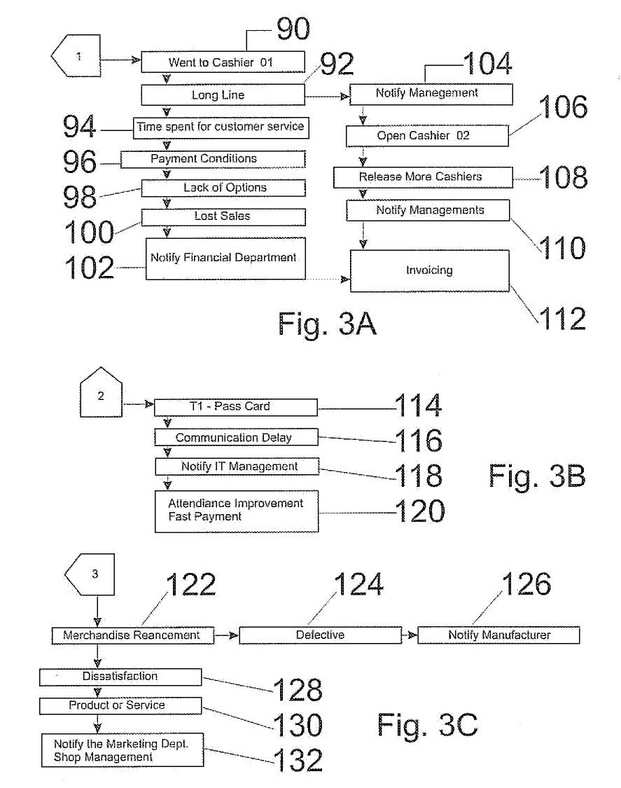

FIGS. 3A, 3B and 3C illustrates a block diagram for situations handled in the data gathering module;

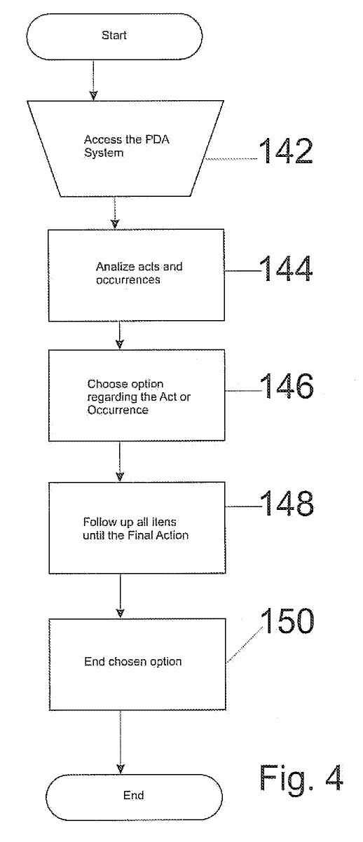

FIG. 4 illustrates a block diagram for the general operation of the data collecting module in accordance with the invention; and

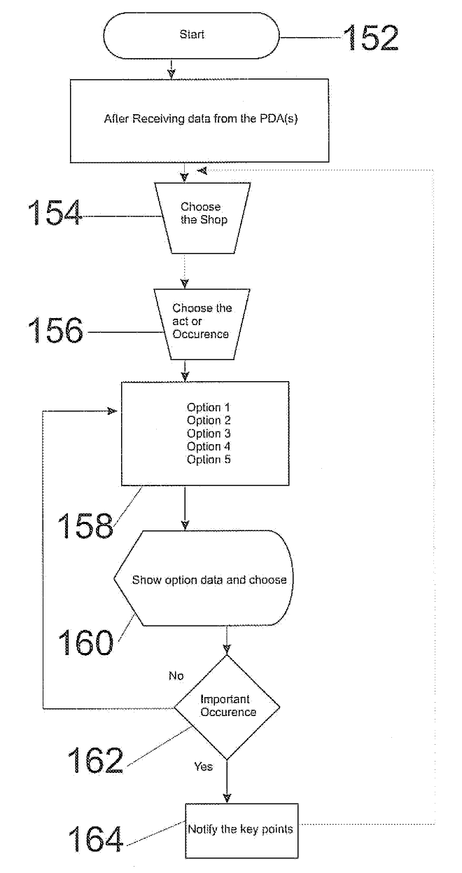

FIG. 5 illustrates a block diagram of a process being implemented in the information receptor module.

### DETAILED DESCRIPTION OF THE INVENTION

Referring to the drawings wherein the same reference numerals refer to the same or similar elements, a computerized system for data collection and management in accordance with the invention is designated generally as 10 and uses, in a first module 12, a portable electronic equipment, with which the data may be collected using for example voice command 14, and immediately transferred, via a cable, a fixed connection support, a network and/or wireless transfer, to a database properly installed and configured on a mainframe, which constitutes a second, information receptor administrative module 16. On the mainframe, correlations for the information collected with the system's pre-defined temporal and statistical parameters are performed with a view toward enabling electronic processing and tabulations of the data. Such data is received in the data gathering module 12, preferably via a voice input made by the operator of the portable electronic equipment, based on the visitors' procedures.

Referring to FIGS. 2A and 2B, the visitors' entrance in a commercial store, for which the system is be designed as “customer store”, is noted 18 and time elapsed between each input for visitors' entrance is also noted at 22.

Associated with such visitor entry information is preferably data about gender, age, and if the visitor is alone or not, 20. With such data, the system is able to obtain the instantaneous and average occupancy of the store, thus allowing, for example, the store's management or commercial center's administration to control the proper air conditioning level for the environment inside the store, to anticipate the need to intensify safety or observation, to allow for a selective programming of promotional events, to take advantage of periods when the store has a higher occupancy, or to even indicate the need to enlarge the facilities of the store to the store's management or for the commercial center administration.

When the visitor leaves the store 24, the data gathering module 12 obtains or generates the motive for leaving, preferably using vocal input, in association with his/her identification, which enables a determination to be made whether, for example, the store is crowded 26. This could be an indication to the store's management or to the commercial center administration that it is necessary to expand the facilities. Also, the determination could be used to notify the air-conditioning administrator 28 and/or the security administrator 30. It also enables a determination to be made whether the traffic in the store is jammed 32 and if so, provide an indication to the store owner that the store is too small 34 and also notify the shopping mall in which the store is located, if any 36. It also enables a determination to be made whether the visitor was not attended to 38, in which case, it could be assessed whether an employee is missing 40 and if so, notify the management of the store 42.

When the visitor's exit is motivated by difficulties in finding the desired item, it can be researched whether the difficulty in locating the item arose from the disarrangement of the articles inside the store 44. This could be used to indicate the need to rearrange the internal space 46, advise of the inappropriate size or smallness of the display space 48 and notify the shopping mall in which the store is located, if any 50. It could also be used to communicate to the stocking department in charge to place the absent item back in stock, or it possible to identify a certain item that is not marketed by the store, which may also indicate, for the commercial center administration, the need to expand the store's facilities.

When the visitor comes to the cashier, a new vocal input is generated and the system monitors the time elapsed until the visitor can conclude the payment for the purchase, a time that must be within the limits predefined in the system. When such limits are surpassed, the situation might indicate to the store's management that it is necessary to open new cashiers or even to expand the payment locations.

When the service is performed at the cashier, a new vocal input is preferably generated, indicating the payment condition and letting management know the store's customers' favorite payment forms. For electronic payments, the system can monitor the time elapsed until the service administrators start providing such service, something which may provide indications about the need to better organize the ways through which such information is transferred.

Once the sale is concluded, a new vocal input is preferably generated, indicating the profile of the purchase for example, whether there are large packages at 134), information about the need to make available personnel to carry the goods at 136, provide personnel to carry the goods to the visitor's vehicle at 138 in addition to collecting data to send loyalty cards and including the score count or a reward in the system at 140.

Referring again to FIGS. 2A and 2B, after parameters of the visitors are identified at 20, a determination may be made and entered via vocal input to the data gathering module 12 about whether the visitor is confused by the shop-windows at 52, whether they delay their purchase at 54 and if so, notification is made via the information receptor module 16 to the store management at 56.

When the visitor leaves the shop 24, information is also gathered about whether the visitor left with companions at 58, and whether the companions participated in the purchase at 60 or not at 66, whether they were approached to purchase something at 62 and then the store's management can be notified of such 64 via the information receptor module 16. If the visitor's companions did not participate in the purchase, data is gathered as to whether the were needed to be located resulting in the visitor putting sales items on hold at 68, whether a waiting room in which the companions waited was full at 70 and then the store's management can be notified of such 72 via the information receptor module 16

Furthermore, when the visitor leaves the shop 24, information is also gathered about whether the sales offerings are satisfactory to the visitor at 74 and whether a sought item was found at 76. In the latter case, when an item is not available at 78, inventory is notified at 80 and a research department is also notified at 82. When an item is not working at 84, the purchasing department is notified at 86, the marketing department is notified at 88 and then the research department is notified at 82.

With reference to FIG. 3A, when the visitor has difficulty locating an item at 44, a determination is made whether the visitor went to a cashier at 90, whether there was a long line at 92, and data is obtained about the time spent waiting for customer service at 94, the payment conditions at 96, the lack of available options requested by the visitor at 98, possible lost sales as a result at 100 and if so, notification can be made to the store's financial department at 102 via the information receptor module 16. When there is a long line, the store's management may be notified at 104, a cashier may be directed to open at 106, more cashiers may be released at 108, the store's management may be notified at 110 via the information receptor module 16 and the data sent to invoicing at 112.

With reference to FIG. 3B, when the visitor uses a credit or pass card to pay for the items at 114, a determination is made whether there is a communication delay at 116 and if so, the store's IT management is notified at 118 and a report about attendance improvement and fast payment can be generated at 120.

With reference to FIG. 3C, a vocal input is also preferably generated when, for example, the visitor enters with the intention of exchanging a product at 122. In this case, the reason for the exchange is identified, possibly revealing that the article has problems or is defective at 124 and leading the store's management to contact the manufacturer or supplier at 126. When the item is not satisfactory at 128, the store's management may have to substitute the item, change the product or service at 130 and then notify the marketing department and/or the store's management at 132.

Referring now to FIG. 4, the system can function by initially requiring access to the data gathering module 12, which may be a PDA or similar handheld or palmtop device. The user accesses the PDA at 142, and uses the PDA to analyze act and occurrences at the store at 144. The user is provided with one or more options regarding the act or occurrence at 146, for example, as described above, the visitor's entry, exit, data about the visitor, and data about the reason for visiting the store. This may be entered via vocal input with the PDA having appropriate voice recognition software to process the vocal input. The user can follow-up at 148 all items regarding each visitor until the final action relating to the act or occurrence, e.g., when the visitor leaves the store. Then, the user ends the selected option at 150.

Referring now to FIG. 5, the information receptor module 16 receives data from the data gathering module 12 or PDA at 152. The information receptor module 16 can receive data from multiple data gathering modules 12 and thus its first step may be to select the store whose information is to be analyzed or reviewed at 154. Then, it is possible to select the act or occurrence at 156 for which a report or spreadsheet is to be generated, the user being presented with multiple options at 158. When each option is selected, the user is provided with the data at 160. If the occurrence is one deemed important at 162, e.g., one for which a response or action must be taken, then the appropriate entity or station is notified at 164. If not, another option can be selected at 158.

Thus, disclosed above is a computerized system for data collection and management which has significant advantages over conventional systems, mainly due to its operational breadth, through which is possible to monitor all situations that might be seen, not only in a store hut also in a commercial center, and that will enable optimization of the operation thereof.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A data collection and management system for collecting data about shoppers in a commercial store, comprising:
a portable electronic device arranged to collect data about shoppers' actions in the store, said portable device having at least one input device to enable a user to input data about the shoppers into said portable device; and
a computer including a database arranged apart from said portable device;
said portable device including transfer means for transferring collected data to said database in said computer,
said computer being arranged to process the collected data in said database to derive information about the visitors.

2. The system of claim 1, wherein said portable device is arranged to receive vocal input of the data about the shoppers' actions.

3. The system of claim 1, where said computer is arranged to perform correlations of the collected data and pre-defined temporal and statistical parameters.

4. The system of claim 1, wherein said portable device is a palmtop device.

5. The system of claim 1, wherein said transfer means comprise at least one of a cable, a fixed connection support, a networks or a wireless transfer system.

6. The system of claim 1, wherein said computer is a mainframe computer.

7. The system of claim 1, wherein said portable device is arranged to receive vocal input when each visitor enters the store and determine a time between entry of sequential visitors, and receive vocal input of information about each visitor and store the entry data of each visitor in association with the information about each visitor.

8. The system of claim 7, wherein said vocal input of information about each visitor includes the visitor's gender, age, presence of a companion.

9. The system of claim 7, wherein said computer is arranged to process the collected data to derive occupancy of the store and determine a busy period for the store to thereby enable adjustment of air-conditioning based on occupancy of the store, allocation of security and observation of the store based on occupancy of the store, enable optimal scheduling of promotional events when the store is busy, and enable notification of a need to expand the store.

10. The system of claim 1, wherein said portable device is arranged to receive vocal input when each visitor leaves the store, receive vocal input of information about each visitor and a reason for leaving the store and associate identification of the visitor and the reason for leaving with the visitor to thereby enable a determination to be made via said computer as to whether the store was crowded, a need for additional employees, a need for additional space, a need to organize the items, a need to restock items, and a need to stock different items.

11. The system of claim 1, wherein said portable device is arranged to receive vocal input when each visitor enters the store to exchange a previously purchased item, and receive vocal input of information about a reason for the exchange to thereby enable a determination to be made via said computer as to a need to contact a manufacturer or supplier of the item or the store's management when the item is indicated as being defective or unsatisfactory.

12. The system of claim 1, wherein said portable device is arranged to receive vocal input when each visitor approaches a cashier to conduct a transaction to thereby enable a determination to be made via said computer as to a need to open new cashiers or expand a cashier area based on the duration of the transactions relative to pre-established transaction duration goals.

13. The system of claim 1, wherein said portable device is arranged to receive vocal input when each visitor makes a payment for items indicating the type of payment to thereby enable a determination to be made via said computer as to visitors' preferred payment method and effectiveness of an electronic payment technique.

14. The system of claim 1, wherein said portable device is arranged to receive vocal input after each visitor makes a payment for items indicating a profile of the purchase to thereby enable a determination to be made of a need to make staff available to carry purchased items and forwarding of cards and inclusion in a reward system.
